(19) United States
(12) Patent Application Publication
(10) Pub. No.: US 2006/0077244 A1
(43) Pub. Date: Apr. 13, 2006

(54) System and method for ink jet printing of water-based inks using ink-receptive coating

(76) Inventor: Paul A. Edwards, Ypsilanti, MI (US)

Correspondence Address: HARNESS, DICKEY & PIERCE, P.L.C., P.O. BOX 828, BLOOMFIELD HILLS, MI, 48303, US

(21) Appl. No.: 10/961,542

(22) Filed: Oct. 8, 2004

(51) Int. Cl. B41J 2/01

(52) U.S. Cl. 347/102

(57) ABSTRACT

A system and method for printing aqueous ink jet ink in selected areas of nonabsorbent and semi-nonabsorbent substrates includes applying an ink-receptive coating in the selected areas, for example with printing station having a printing and drying unit for applying the ink-receptive coating in the desired area or areas of the substrate and then drying the coating, and printing an aqueous ink jet ink in the coated area with an ink jet printer. Variable print maybe printed with the in jet ink in a high speed process.

### FIELD OF THE INVENTION

The invention relates to systems and methods for ink jet printing, including drop-on-demand (DOD) technologies such as thermal ink jet (TIJ) and piezoelectric ink jet (PIJ) and particularly including continuous ink jet (CIJ) printing, using aqueous inks.

### BACKGROUND OF THE INVENTION

High-speed printing of variable images, such as variable text, numbers, bar codes, or graphics, is often done by continuous ink jet (CIJ) printing due to its high speed, but new TIJ and PIJ printing systems can often be used in these high speed applications also. The article to which the variable print is applied may be a paper web being printed on a press, rolls of packaging materials such as plastics, or products that have already been formed. In general, the substrate is printed in full color with process colors before the variable text is applied. Conventional presses have five or more printing stations, one each for application of cyan, magenta, yellow, and black and additional printing stations for spot colors, glossy coating, or for enhanced process color sets with six, seven, or more colors. A printing station will include the ink application rollers and may also include a heat dryer or actinic radiation source. A suitable continuous ink jet printer (or TIJ or PIJ printer) may be located in-line with the press where the variable image is applied as a final printing step, or the ink jet printer may be in another location for off-line application of the variable image, e.g. at a mail table where addresses are added to already-printed material.

Printing water-based ink jet inks using single and binary jet ink jet systems is preferred because it avoids the hazards and regulated emissions of solvent-based inks. Water-based inks have been restricted by their nature, however, to printing on very porous substrates that can quickly absorb the water in the ink so that the drying period is short for subsequent handling of the printed substrate. Water-absorption of the substrate may be enhanced by ink-receptive coatings applied to one or both faces of the substrate. Coated papers have a generally low gloss. Thus, high speed binary array systems such as Scitex® one-inch, two-inch, and four-inch printers (available from Kodak Versamark) or printers based on Hewlett-Packard TIJ heads have been used in high speed printing of water-based inks onto absorbent and partially absorbent papers only.

High-speed jet printing with water-based inks has not been successful for nonabsorbent substrates or substrates with little absorbency (semi-nonabsorbent substrates) such as high gloss stock. Nonabsorbent and semi-nonabsorbent substrates may be used in printing magazine cover and packaging, for instance, for which it would also be desirable to use a binary jet CIJ/TIJ/PIJ station to imprint variable text, numbers, bar codes, or graphics onto selected areas of the substrate for, e.g., product coding, addressing, or customizing. When water-based ink is printed at the ink jet station the presses must either be run at low speeds or given long drying tracks to accommodate the slow evaporation of water in drying the ink because the ink must dry before the print reaches a turnover roller to prevent smearing. Both running the presses at slow speed and using long drying tracks are undesirable as inefficient and costly. A drying station may be installed if there is room, but again this adds to cost.

Attempts have been made to adjust the ink formulation to achieve greater penetration on semi-impermeable stock with modest improvements of perhaps 10-15 percent in the drying rate. Formulating at higher solids and with polymeric dyes to reduce the amount of water in the ink to evaporate may also reduce drying rate by 20 or 30 percent, but these high solids inks also have higher viscosities and cannot be printed using conventional continuous binary ink jet printers.

### SUMMARY OF THE INVENTION

The present invention provides a system and method for printing aqueous ink, particularly by CIJ but also by TIJ or PIJ, in selected areas of nonabsorbent and semi-nonabsorbent substrates. The system has a press with a printing station for applying an ink-receptive coating to the desired area or areas of the substrate and an ink jet printer positioned to apply a variable print in the coated area. Optionally, a dryer may be used to dry or cure the ink-receptive coating as needed before the ink jet printer, or the coating may dry by air. The coated substrate may pass through further print stations where ink is applied. An “ink receptive coating” is a coating that readily absorbs the ink. Since the ink is readily absorbed, the drop spread is minimal and the printed substrate can be further handled as though it were dry. It is believed that the ink, or at least the water in the ink, is trapped in the receptive coating matrix and/or porous particles, and dries over time. The ink-receptive coating contains the ink and the surface is not tacky.

In one embodiment, the invention provides a system for printing nonabsorbent and semi-absorbent substrates, the system including a printing press having at least five stations, one of which is used to apply an ink-receptive coating to the desired area or areas of a substrate. The system further includes an ink jet printer (such as a CIJ printer) positioned to apply a variable print in the coated area.

The present invention provides a method of printing an aqueous CIJ, TIJ, or PIJ ink in at least one selected area of a substrate, in which an ink-receptive coating is applied in the selected area before the ink jet ink is printed. In various embodiments, one or more of variable text, numbers, bar codes, or graphics are printed with an aqueous ink jet ink in the at least one selected area of the substrate. Also in various embodiments, a heater or source of actinic radiation is used to dry or cure the coating before the aqueous ink jet ink is printed in the coated area.

The printing method of the present invention can provide substantial improvements in the drying rate of ink jet print (as determined by when the print can be processed by handling, rolling up, and so on), such as 50 to 90 percent. Using the inventive method or system, even nonporous substrates, such as very high gloss stock, metal, coated substrates, and plastics, can be printed with a continuous ink jet printing without long drying tracks, slow printing speeds, or costly or inefficient modifications to the press. The print quality is substantially improved, and there is more consistency in print quality between different substrates. Because the coating is only applied in the area to be printed with the waterborne ink jet ink, the finish on the remainder of the substrate is unaffected in appearance.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### BRIEF DESCRIPTION OF THE DRAWINGS

The present invention will become more fully understood from the detailed description and the accompanying drawings, wherein:

FIG. 1 is a block diagram of an embodiment of a system of the invention for web printing;

FIG. 2 is a block diagram of a mail table embodiment of the invention; and

FIG. 3 illustrates an area of a substrate printing using a method of the invention.

### DETAILED DESCRIPTION OF THE PREFERRED EMBODIMENTS

The following description of the preferred embodiment(s) is merely exemplary in nature and is in no way intended to limit the invention, its application, or uses.

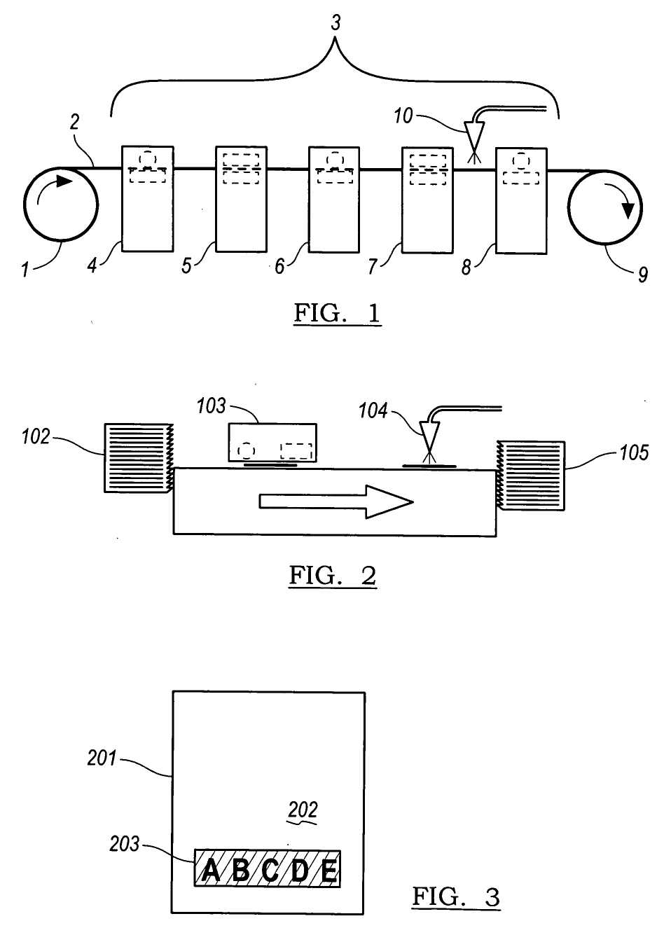

The inventive system and method provide a means of printing aqueous ink jet ink in selected areas of nonabsorbent and semi-nonabsorbent substrates. The system has a press with a coating station having a printing unit and, optionally, a heat or radiative source for applying an ink-receptive coating to the desired area or areas of the substrate and then drying or curing the coating and a CIJ, TIJ, or PIJ printer positioned to apply a variable print in the coated area. Referring first to FIG. 1, a web 2 of a nonabsorbent and semi-nonabsorbent substrate unwinds from roll 1, passes through press 3 having five printing stations 4, 5, 6, 7, and 8 and rolls up on roll 9. Press 3 may, for example, print by flexography or by intaglio or gravure. An ink jet printing unit 10 prints a desired area of the substrate between printing stations 7 and 8.

The ink-receptive coating may be applied using a print station already available on the press and, therefore, no additional equipment must be installed. The press illustrated In FIG. 1 has five print stations, but other presses may have more than five print stations. For example, then, in FIG. 1 one of print stations 4-7 may be selected to apply an ink-receptive coating onto the substrate. The coating is printed onto a specific area, or more than one specific area, on the substrate. If there is at least one additional print station between the print station applying the coating and the CIJ, TIJ, or PIJ printer, the coating may dry sufficiently before it reaches the ink jet print head without heat, or may be dried by a heat source associated with the additional print station or stations. Thus, referring again to FIG. 1, the ink receptive coating may be applied with one of print stations 4, 5, or 6, then dried without heat before reaching ink jet printing unit 10, or the ink receptive coating may be dried by a heat source or cured by a radiative source located after the coating is applied. The applied coating may not need to dry fully before reaching the CIJ, TIJ, or PIJ printhead, so long as it attains sufficient ink receptiveness so that when the surface contacts a roller or other equipment the ink jet print remains acceptable in appearance. The ink-receptive coating may also be applied in print station 7, particularly if the print station includes a thermal dryer or if the coating is cured with actinic radiation.

Examples of nonabsorbent or semi-nonabsorbent substrates include, without limitation, high gloss, satin, or coated paper or paperboard and plastic (e.g., polyethylene, polypropylene, vinyl, or polyester), which may be supplied as webs, rolls, or sheets, as well as plastic and metal packaging materials.

The press may be, for example, a flexographic press or gravure press. In various other embodiments, the ink-receptive coating may be applied to the desired area(s) by pad printing, spray printing, or ink jet printing.

Ink-receptive coating compositions are known per se. Typical ink-receptive coating compositions are aqueous and include a polymer or resin, preferably one or more film-forming polymers or resins, and absorbent particles. The ink-receptive coating composition could also be solvent-based. Examples of suitable polymers and resins include, without limitation, water soluble or dispersible film-forming polymers and/or latex polymers such as poly(vinyl alcohol), poly(vinyl acetate), copolymers of vinyl acetate, hydroxyethyl cellulose, methyl cellulose, carboxy methyl cellulose, starch, gum arabic, polyethylene glycol poly(vinyl pyrrolidone), polyacrylamide, polypropylene glycol, gelatin, and combinations of these. The ink-receptive coating may also be formulated with materials that cure by exposure to actinic radiation, particularly free-radical curing monomers and oligomers and cationically-curing monomers and oligomers. Examples of absorbent particles include, without limitation, highly porous silica, cationic, porous inorganic oxides, particularly silica gels such as silica hydrogels, aerogels, xerogels, cogels, and other inorganic oxides such as alumina, silica/alumina, and titania, as well as polymeric absorbents such as crosslinked PVP polymer particles. In general, inorganic oxides having pore volumes of 0.6 cc/g or more are preferred, particularly those having pore volumes of 0.6 to 3.00 cc/g are suitable. Also in general, the average particle size should be in the range of 1 to 20 microns, preferably about 3 to about 12 microns, particularly preferably about 5 to about 8 microns.

The porous, absorbent particles may be included at amounts of 20 to 80 percent by weight, preferably at least 40 percent by weight, of the nonvolatile components of the ink-receptive coating composition. Higher amounts of porous, absorbent particles allow the printed surface of the coating to be resistant to blocking after little actual drying of the waterborne ink jet ink. Instead of drying, the ink is absorbed into the porous particles, which prevent smearing and release the water from the ink over time. Such coatings are matt and translucent. In various embodiments, ink-receptive coating compositions may include other components such as optical brighteners, crosslinking agents such as dryers for the polymer or resin, dispersants, lubricants, preservatives, antifoam additives drop size color additives, color fade reduction additives, and so on.

In general, the coating composition is applied at rates of about 2 to about 30 g/m², preferably from about 10 to about 20 g/m². The ink-receptive coating can be applied in the desired area or areas using conventional printing methods such as flexography, gravure, pad printing, spray deposition, and so on. The coating is applied to areas that will receive variable print. Variable print is typically applied to a specific area of print stock, for instance a bar code applied on the bottom or back of packaging, an address applied in a corner on the front of a magazine cover, personalization on a product, or short- or special-run advertising that may be placed anywhere on a product.

The ink receptive coating may be formulated to be curable on exposure to actinic radiation, in which case the printing station may include a source of actinic radiation to which the coating is exposed after application to the substrate. In various embodiments, the print station may include a heater for at least partially drying the applied coating. The applied coating layer can be dried, for example, at room temperature, by hot air drying, heat surface-contact drying, or heat radiation drying. Curable applied coating layers can be cured under appropriate conditions, such as thermally or by exposure to actinic radiation, as mentioned.

The substrate may be printed with repetitive print at other print stations of the press, typically using process colors (e.g., CMYK) for full color print.

The aqueous ink jet ink may be applied, for example, with single jet or high speed, binary array printer such as Scitex Kodak Versamark 6240, Domino A300, Videojet Printpro, as well as printers based on Hewlett Packard or other TIJ head technology and PIJ head technology from Spectra, Xaar, Epson or others. Typically, the ink jet printer is used to apply variable text, numbers, bar codes, or graphics in the selected areas that have been coated with the ink-receptive coating. For example, a cover of a glossy magazine printed on a conventional web press (flexo or gravure) receives coating in selected areas, which could be over part of the repetitive print or on unprinted areas, at one printing station and variable text such as mailing address, subscription information, and bar codes may be printed with waterborne ink by a continuous ink jet printer.

The ink-receptive coating and water-based ink jet ink may also be applied onto nonabsorbent and semi-nonabsorbent stock that has already been printed. For example, as illustrated in FIG. 2, printed, nonabsorbent or semi-nonabsorbent substrates, for example magazines with glossy covers, are imprinted using a mail table. On one side of the mail table is a stack 102 of magazine cover sheets having nonabsorbent or semi-nonabsorbent surfaces. The sheets are passed one by one through print station 103, which may be, for example, a flexographic print station or a gravure print station. Print station 103 applies an ink-receptive coating in one or more areas or “knock outs” on the sheet. Print station 103 includes a heater or other unit to at least partially dry the applied coating, after which the sheet passes to an ink jet printhead 104. Ink jet printhead 104 applies a variable print using a waterborne ink. The printed sheet may then pass to a heater [not shown] or actinic radiation source [not shown], as appropriate for the particular waterborne ink selected. The sheet then passes to stack 105 of sheets printed with variable print. A mail table typically enables medium or high speed, off-line printing of variable text, while variable text can be applied at very high speed in an in-line process such as that discussed with reference to FIG. 1.

FIG. 3 illustrates a portion of a sheet printed with variable print. Sheet section 201 has an area 202 of full-color, glossy print and a “knock out” area 203 with an ink-receptive coating. Inside the “knock out” area 203 is representative variable text printed with an aqueous continuous ink jet ink.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of printing an aqueous ink on at least one selected area of a nonabsorbent and semi-nonabsorbent substrate, comprising steps of:
applying an ink-receptive coating to the selected area of the substrate,
at least partially drying the coating,
and printing an aqueous ink jet ink on the coating.

2. A method according to claim 1, wherein the ink-receptive coating is applied using a flexographic printing station, a gravure printing station, or pad printing.

3. A method according to claim 1, wherein the aqueous ink jet ink is printed with a continuous ink jet printer.

4. A method according to claim 1, wherein the coating is at least partially dried with heat.

5. A method according to claim 1, wherein the coating is cured by exposure to actinic radiation or thermally or both by exposure to actinic radiation and thermally.

6. A method of printing variable print in selected areas on a nonabsorbent or semi-nonabsorbent web or roll of a substrate, comprising steps of:
applying an ink-receptive coating to the selected areas,
at least partially drying the coating,
and printing an aqueous ink jet ink on the coating in variable print.

7. A method according to claim 6, wherein the ink-receptive coating is applied using a print station of a web flexographic or gravure press or by pad printing.

8. A method according to claim 7, wherein repetitive print is applied at one or more additional print stations of the press.

9. A method according to claim 7, wherein the print station includes a thermal dryer.

10. A method according to claim 6, wherein, in the variable print is selected from the group consisting of variable text, variable numbers, variable bar codes, and variable graphics.

11. A method of continuously printing variable print in selected areas on sheets of nonabsorbent or semi-nonabsorbent substrate, comprising steps of:
applying to the selected area on each sheet an ink-receptive coating;
at least partially drying the coating; and
printing an aqueous ink jet ink in variable print in the area with an ink jet printer.

12. A method according to claim 11, wherein the ink-receptive coating is applied using a print station of a press.

13. A method according to claim 12, wherein repetitive print is applied at one or more additional print stations of the press.

14. A method according to claim 12, wherein the print station includes a thermal dryer.

15. A method according to claim 11, wherein, in the variable print is selected from the group consisting of variable text, variable numbers, variable bar codes, and variable graphics.

16. A method according to claim 1 1, wherein the sheets of nonabsorbent or semi-nonabsorbent substrate are printed before the ink-receptive coating is applied.

17. A method according to claim 11, wherein the method is carried out using a mail table.

18. A method according to claim 17, wherein the applied coating is at least partially dried or cured before printing the aqueous ink jet ink.

19. A method of printing variable text on nonabsorbent or semi-nonabsorbent substrate using a printing press having multiple print stations, comprising steps of:
applying repetitive print with one to less than all of the print stations;
applying an ink-receptive coating in a selected area of the substrate with one of the print stations;
at least partially drying or curing the ink-receptive coating; and
applying a waterborne ink in the area of the ink receptive coating to form a variable print using an ink jet printer.

20. A method according to claim 19, wherein the coating is applied over a part of the substrate having repetitive print.

21. A method according to claim 19, wherein the coating is applied over a part of the substrate not having repetitive print.

22. A method according to claim 19, wherein the coating comprises an aqueous polymer or resin and absorbent particles.

23. A method according to claim 19, wherein the coating is cured by exposure to actinic radiation.

24. A method according to claim 19, wherein the coating is matt and translucent.

25. A method according to claim 19, wherein the coating comprises a member selected from the group consisting of highly porous silica, silica gels, alumina, silica/alumina, titania, and combinations thereof.

26. A method according to claim 19, wherein the coating comprises an inorganic oxide having a pore volume of at least about 0.6 cc/g.

27. A method according to claim 19, wherein the coating comprises an inorganic oxide having a pore volume of 0.6 to 3.00 cc/g.

28. A method according to claim 19, wherein a print station is located between the print station applying the ink-receptive coating and the ink jet printer.

29. A method according to claim 19, wherein the coating is translucent and matt.

30. A system for printing variable text in a selected area of a nonabsorbent or semi-nonabsorbent substrate, comprising
a press with a printing station having a printing unit that applies an ink-receptive coating to the selected area and
an ink jet printer positioned to apply a variable print in the coated area.

31. A system according to claim 30, wherein the continuous ink jet printer applies an aqueous ink in the coated area.

32. A system according to claim 30, wherein the press is a flexographic press or a gravure press.

33. A system according to claim 30, wherein the press has at least one additional printing station that applies a repetitive image.

34. A system according to claim 30, wherein the press has at least one additional printing station between the printing station having a printing unit that applies an ink-receptive coating and the ink jet printer.

35. A system according to claim 30, wherein the printing station having a printing unit that applies an ink-receptive coating comprises a heat or radiative source for drying or curing or both drying and curing the applied coating.

36. A mail table, comprising
a print station that applies an ink-receptive coating in one or more areas of a nonabsorbent or semi-nonabsorbent, printed sheet fed onto the mail table,
a heater that at least partially dries the applied coating or a source of actinic radiation that at least partially cures the applied coating, and
an ink jet print head that applies a variable print to the one or more areas using an aqueous ink.
